(19) United States
(12) Patent Application Publication
(10) Pub. No.: US 2020/0323154 A1
(43) Pub. Date: Oct. 15, 2020

(54) SELF-CONTAINED LIVING MOSS WALL ECO-SYSTEM

(71) Applicant: Moss Mats, LLC, Honesdale, PA (US)

(72) Inventors: David Alan BENNER, Honesdale, PA (US); James FUCETOLA, Honesdale, PA (US)

(21) Appl. No.: 16/843,437

(22) Filed: Apr. 8, 2020

Related U.S. Application Data
(60) Provisional application No. 62/831,358, filed on Apr. 9, 2019.

(51) Int. Cl. A01G 22/30; A01G 31/02; A01G 25/16

(52) U.S. Cl. CPC A01G 22/30; A01G 25/16; A01G 31/02

(57) ABSTRACT

A living moss wall system is provided. The living moss wall system includes an automated mist delivery system that evenly applies mist to the vertical moss panel from in front of the moss wall and back onto the vertical moss panel.

### CROSS-REFERENCE TO RELATED APPLICATIONS

This application claims priority to U.S. Provisional Patent Application No. 62/831,358, filed Apr. 9, 2019, entitled “Self-Contained Living Moss Wall Eco-System,” currently pending, the entire disclosure of which is incorporated by reference herein.

### BACKGROUND OF THE INVENTION

Indoor air suffers from dryness and an overabundance of positively charged ions that hold on to dust and pollutant particles. This stale and polluted air impacts mood, work place efficiency and human health. Therefore, it would be beneficial to provide a system which treats this condition by simultaneously moistening the air, oxygenating it, and removing fine particulate air pollutants by combining misters with moss.

### BRIEF SUMMARY OF THE INVENTION

A self-contained living moss wall eco-system for cleansing and oxygenating interior working/living space is provided.

The present invention relates to a system that encourages moss to flourish and grow in a self-contained and controlled indoor environment, while simultaneously cleansing, humidifying, and oxygenating the indoor air. The system consists of a frame structure to hold and support a vertical panel of live moss that is affixed to a water proof backer board.

In one embodiment, positioned at the top of the frame and hidden from view are waterproof LED lights and a horizontal tube with several mister heads. These lights and misters are controlled by a timer/app that turns them on at the proper intervals and durations to keep the moss alive and healthy. At the base of the vertical moss garden frame is an attached water catchment basin on which a mesh grate and filter fabric are placed to allow for the planting of a horizontal moss, fern and shade plant garden. This catchment basin element is important as it allows for the mist from above to land on the moss garden below, not on the floor, and then drip over time down into the catch basin below.

The water catchment basin also has a submersed pump with an internal UV sterilization lamp for helping to kill off unwanted and harmful mold spores, bacteria, viruses, pollens and algae that otherwise could harm the moss and/or contaminate the surrounding air. The catchment basin also has a separate covered section—a dry compartment where the booster pump that powers the misters, timers, and other electronics, plugs and cords are housed. The booster pump utilizes a suction tube to draw water from the adjacent water catchment basin and deliver it under pressure to the mister heads at the top of the moss wall. It is important to note that moss has no true roots and gets all its nutrients and water by absorption through the moss plant leaves. The misters are not only important for the health of the moss, but they are also very important for producing a fine mist of water molecules and negative ions that attract dust, pollen, and other airborne pollutants and then deliver those pollutant particles to both the vertical panel of live moss and the horizontal moss garden where they are both captured and broken down over time by beneficial microbes that reside in the moss. This, in turn, cleanses and purifies the indoor air for the room or facility in which the living moss wall system is placed.

The figures provided herewith include a view of the entire live moss wall system (4′ wide×8′ tall—stainless steel cabinet) and a view from above of the attached water basin with moss garden covering.

### BRIEF DESCRIPTION OF THE SEVERAL VIEWS OF THE DRAWINGS

The following detailed description of preferred embodiments of the present invention will be better understood when read in conjunction with the appended drawing. For the purposes of illustrating the invention, there is shown in the drawing an embodiment which is presently preferred. It is understood, however, that the invention is not limited to the precise arrangements and instrumentalities shown. In the drawings:

FIG. 1 shows a living moss wall system according to an embodiment of the present invention;

FIG. 2 shows an enlarged view of a portion of the living moss wall system shown in FIG. 1;

FIG. 3 shows the light and misting assembly of the living moss wall system shown in FIG. 1;

FIG. 4 shows a pressure/booster pump of the living moss wall system shown in FIG. 1;

FIG. 5 shows a microprocessor of the living moss wall system shown in FIG. 8;

FIG. 6 shows the drainage basin of the living moss wall system shown in FIG. 1;

FIG. 7 shows the drainage basin of the living moss wall system shown in FIG. 1;

FIG. 8 shows a living moss wall system according to another embodiment of the present invention, which is the same as that shown in FIGS. 1-7, but which includes a movable misting assembly; and

FIG. 9 shows the living moss wall system shown in FIG. 8 with the misting bar in a different position.

### DETAILED DESCRIPTION OF THE INVENTION

The system according to the present invention treats stale and polluted air holistically by simultaneously moistening the air, oxygenating it, and removing fine particulate air pollutants by combining misters with moss. The misters force water vapor (water molecules) and negative ions into the air. These water molecules and negative ions attract and latch onto the air pollutant particles and when these molecules and ions with attached pollutant particles come in contact with the moss, they are captured on all the fine leaves and vast surface areas of the moss plants. The live moss plants are kept alive and flourishing with the misters and in return the moss gives off vast amounts of oxygen to re-oxygenate the indoor air. Microbes present on the live moss then break down the various pollutants and are then absorbed and assimilated by the moss. The moss cannot cleanse the air without the misters, nor can the mist be captured and the pollutants be retained without the live moss plants.

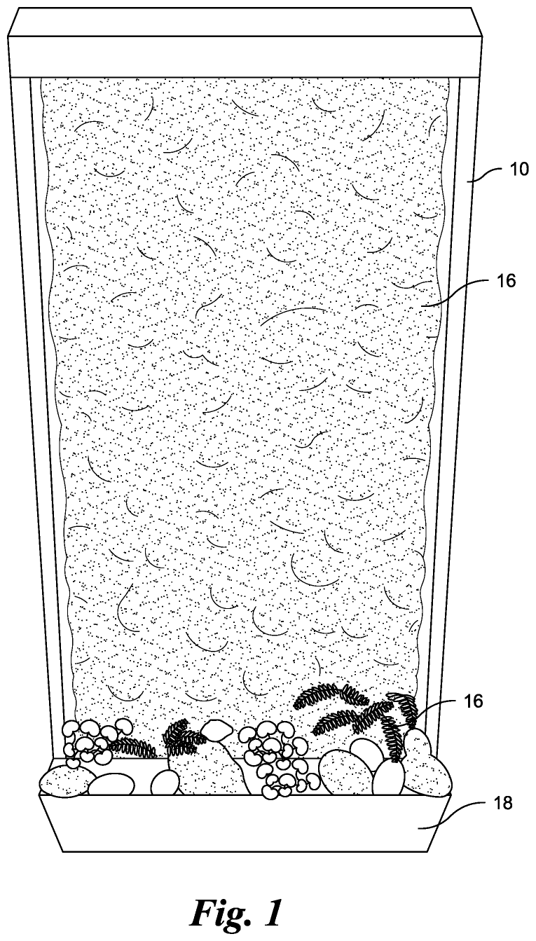

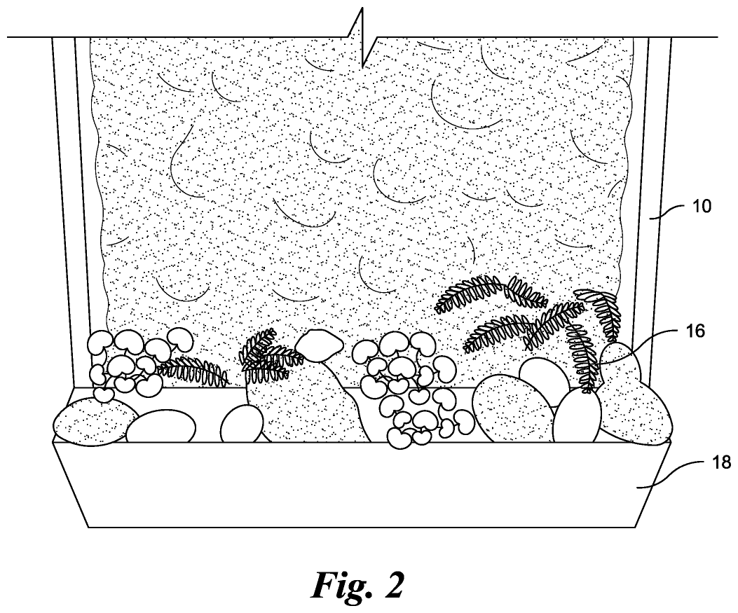

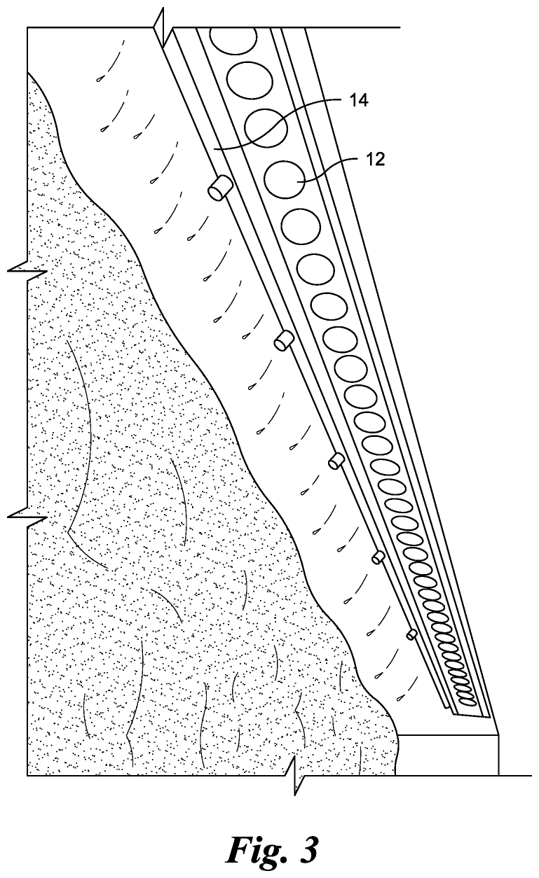

The living moss wall system (FIG. 1) is designed to be self-contained so that the water continuously is recycled as it would be in nature. In one embodiment, positioned at the top of the frame 10 and hidden from view are waterproof LED lights 12 and a horizontal tube 14 with several mister heads. The mist floats down the face of the moss wall 16 and eventually lands on the moss garden 16 atop the drainage basin 18 (FIG. 2). Over time, this moisture accumulates and percolates down through the moss and passes through a charcoal mesh filter and eventually through a metal grate to the pool of water below in the basin. The misters and lights (FIG. 3) are set and controlled by an app that can be set to the exact duration for when the moss wall requires water and light—every site, even indoors, is different. A low water sensor is also in the basin. When the basin is low on water, a text is sent and/or an audible buzzer goes off to signal that additional water needs to be added.

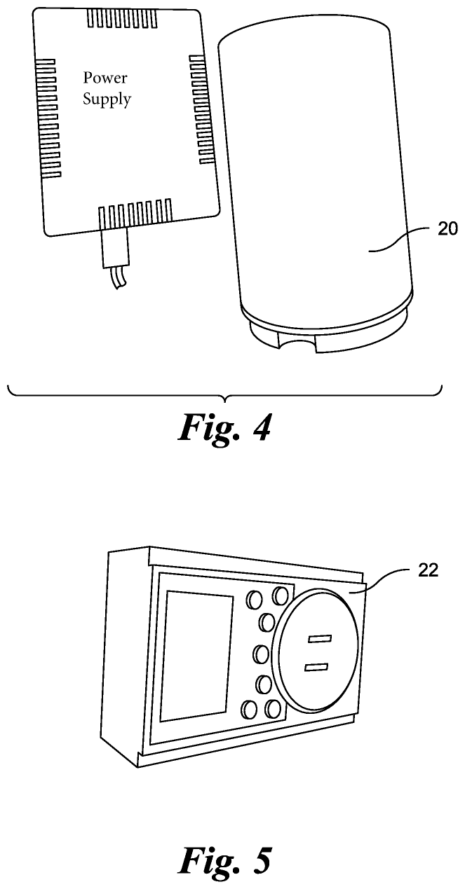

A pressure/booster pump 20 (FIG. 4) is contained inside a dry compartment (hidden beneath the moss garden on left side of basin) The pump is accessed through a hatch in the back side of stainless steel drainage basin. The pump draws water from the drainage basin and pumps it under pressure to the mister heads located along the top of the cabinet just behind the lights. A timer turns the pump and lights off and on as needed.

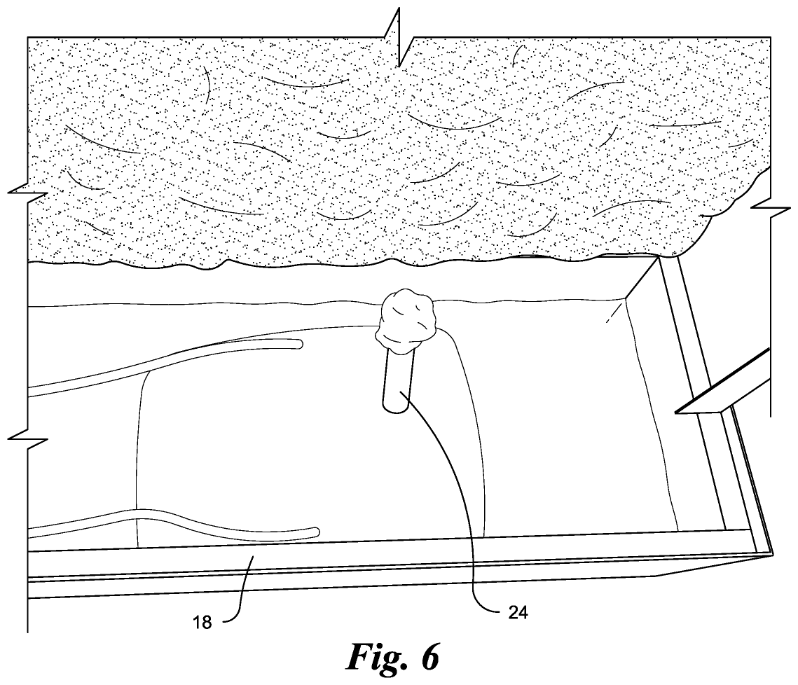

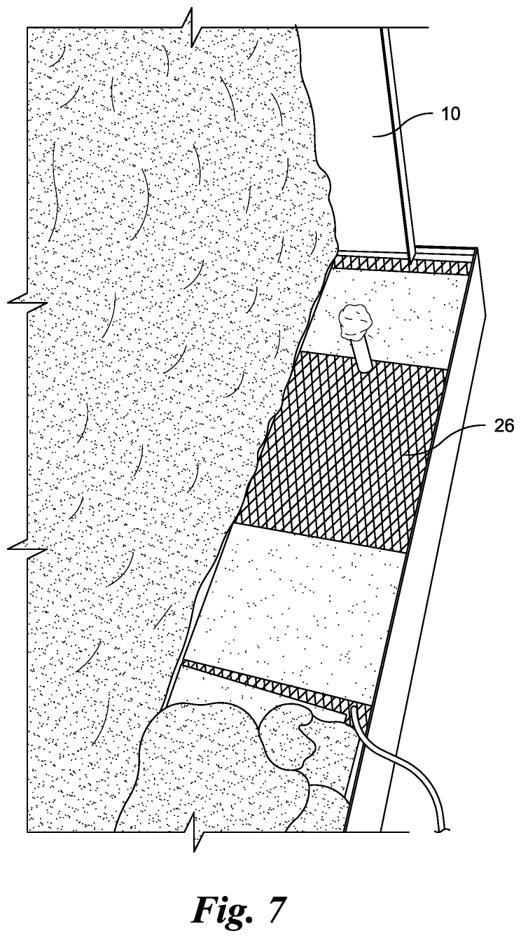

A recirculating pump 24 with UV sterilization light bulb inside (FIG. 6) recirculates water from the basin up through the covering grate 26 (FIG. 7) and the water falls back down into the drainage basin. This feature is not only for aesthetic purposes, but rather the moving water further helps to humidify dry indoor air and the UV light ensures any bacteria, mold, algae, or other pathogens or organisms harmful to the moss or the quality of the indoor air are killed off as the water passes through the pump and past the UV sterilization bulb.

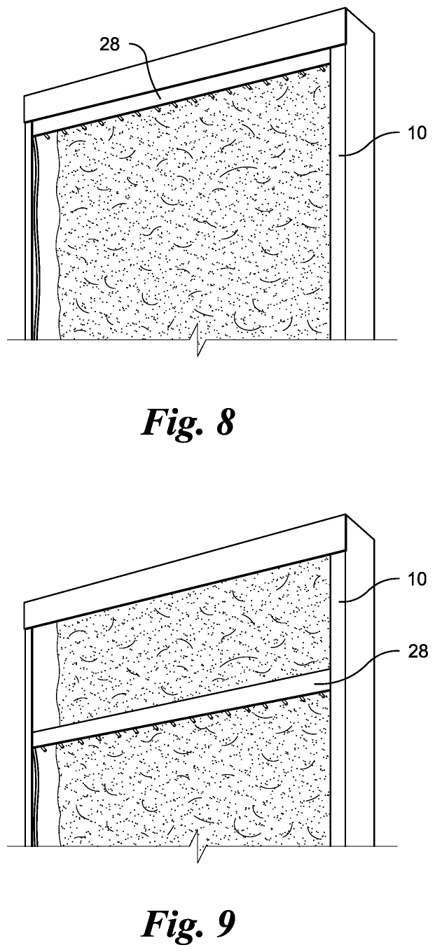

Referring to FIGS. 8-9, in another embodiment, instead of positioning the LED lights and mister heads at the top of the frame, a movable assembly is provided for delivery of the mist. More particularly, the living moss wall system includes an automated mist delivery system that evenly applies mist to the vertical moss panel from in front of the moss wall and back onto the vertical moss panel. The automated mist delivery system includes a horizontal metal member or plate 28 configured to move from one end to the other end of the frame and deliver mist to the moss wall as it moves. Preferably, the metal plate is formed of stainless steel. Preferably, the metal plate has a height of approximately two inches. Preferably, the metal plate is automatically deployed at a pre-determined speed and frequency to apply just a small amount of water via mister heads. Preferably, a water feed line is attached to a back surface of the metal plate (i.e., the surface facing the moss wall) and a plurality of mister heads are provided in a spaced apart manner, preferably approximately 1.5 inches apart, all along the horizontal water feed line. By this water feed line and mister head assembly, and because of the plate's proximity to the moss wall (i.e., the plate is preferably approximately 5.5 to 6 inches from the moss wall), the misters apply an even layer of mist to the moss.

In a preferred embodiment, the mister line is positioned on top of a foot (preferably of a length of approximately 0.5 inches) provided on the back surface of the metal plate at the bottom end of the metal plate. The metal plate therefore forms an “L” shape with the foot of the “L” facing the moss wall.

The mister assembly is automatically lowered and raised by a tubular motor, similar to the type used for automated window blinds, positioned within the top end of the frame and hidden from view. To accomplish this, the metal plate is preferably suspended from two chains, cables or straps (one on either end of the plate). That is, one end of each cable is attached to opposing ends of the metal plate, and the other end of each cable is wound around an uptake reel that is positioned over a tube (preferably an aluminum tube) that is attached to the tubular motor. The metal plate is at least slightly shorter in length than the width of the interior dimension of the moss wall, which allows the metal plate to be raised and lowered within the bounds of the frame of the modular moss wall system.

Preferably, the entire front vertical lip of the frame on either side of the moss wall system is turned inwardly, preferably by approximately 2 inches, which prevents the metal plate from swinging outwardly when the mister line is engaged and misting. The pressure of the mister heads, when engaged, pushes the metal plate gently against the turned-in lip of the frame on either side, thereby keeping the mister plate from swinging.

The mister heads spray mist simultaneously as the metal plate to which they are attached, is lowered and/or raised. When the metal plate is in an idle state (i.e., not spraying the moss wall), the metal plate is retracted by the tubular motor assembly back up into the top of the cabinet.

The frequency and duration of the misting are timed such that the moss is kept moist just during the daytime and evening hours when the lights are on, but is then allowed to dry out at night so as to avoid mildew from being able to grow on the moss. To ensure that the moss and backer mat to which the moss is adhered are completely dried out from time to time in order to break the mold spore germination cycle, there are preferably two small automated fans in the top of the stainless-steel cabinet. The fans periodically circulate air at a speed sufficient to create proper air flow so that mold and mildew cannot easily grow on the moss. The duration and frequency of the operation of the fans and of the misting may vary and be adjusted based on the specific conditions of each site in which the living moss wall system is located, as to ensure that mold and mildew cannot become established.

In one embodiment, the system includes a microprocessor 22 (FIG. 5) that turns off and on all of the various components of the system, such as the lights, water feature, misters/mister pump, and fans. The system may also include a relative humidity sensor that signals the microprocessor or controller to turn on the misters when the moss begins to dry out. In another embodiment, essential oils are added to the water basin, and the oils get distributed into the air by the misters and can help reduce airborne bacteria and viruses.

In addition to even misting, even lighting is required by the moss for proper and uniform growth across the moss wall. Thus, the back surface of the horizontal metal plate is preferably also provided with a plurality of LED lights. For example, multiple rows of approximately ⅜″ wide peel and stick LED grow light strips may be adhered to the back surface of the metal plate. The lights preferably provide even lighting to the moss wall, as the metal plate is moved from position to position up and down the face of the moss wall, such that even and sufficient amounts of the proper wavelengths of light are provided to the moss in order to keep the moss plants healthy. The LED grow lights used are preferably 50% red wavelength and 50% blue light bulbs, so as to provide the proper balance of light spectrum for the moss.

The self-contained living moss wall system obviously beautifies indoor spaces, but more importantly it helps improve overall indoor air quality. By combining live moss and water forced under pressure that captures pollutants and delivers these pollutants to the live moss that in turn metabolize those airborne pollutants and use them, light and moisture to in turn produce oxygen for the indoor work/living space.

I/We claim:

1. The self-contained living moss wall systems for cleansing, humidifying, and oxygenating indoor air as substantially disclosed herein with reference to the enclosed drawings.

2. The methods for cleansing, humidifying, and oxygenating indoor air by a self-contained living moss wall system as substantially disclosed herein with reference to the enclosed drawings.
